(19) United States
(12) Patent Application Publication
(10) Pub. No.: US 2024/0380134 A1
(43) Pub. Date: Nov. 14, 2024

(54) SET COMPRISING A CONDUCTOR CONNECTION TERMINAL AND AN ACCESSORY ELEMENT

(71) Applicant: WAGO Verwaltungsgesellschaft mbH, Minden (DE)

(72) Inventors: Michael MEYER, Wiedensahl (DE); Gunter SPEY, Heuerssen (DE)

(73) Assignee: WAGO Verwaltungsgesellschaft mbH, Minden (DE)

(21) Appl. No.: 18/783,411

(22) Filed: Jul. 25, 2024

Related U.S. Application Data
(63) Continuation of application No. PCT/EP2022/087030, filed on Dec. 20, 2022.

(30) Foreign Application Priority Data
Jan. 26, 2022 (DE) 20 2022 100 453.6

(51) Int. Cl. H01R 4/48; H01R 9/24

(52) U.S. Cl. CPC H01R 4/483; H01R 4/4846; H01R 9/2458; H01R 9/2475

(57) ABSTRACT

A set comprising a conductor connection terminal and an accessory element for fastening to the conductor connection terminal. The conductor connection terminal has a conductor connection for connecting an electrical conductor and has a conductor insertion channel for inserting and guiding the electrical conductor to the conductor connection. The conductor connection terminal has, in addition to the conductor insertion channel, an accessory insertion channel, in which the accessory element can be selectively fastened with a fastening section of the accessory element.

This nonprovisional application is a continuation of International Application No. PCT/EP2022/087030, which was filed on Dec. 20, 2022, and which claims priority to German Patent Application No. 20 2022 100 453.6, which was filed in Germany on Jan. 26, 2022, and which are both herein incorporated by reference.

### BACKGROUND OF THE INVENTION

### Field of the Invention

The invention relates to a set comprising a conductor connection terminal and an accessory element. The accessory element is provided for fastening to the conductor connection terminal. The conductor connection terminal has a conductor connection for connecting an electrical conductor and a conductor insertion channel for inserting and guiding the electrical conductor to the conductor connection.

### Description of the Background Art

Conductor connection terminals with a conductor connection for connecting an electrical conductor and with a conductor insertion channel are part of the state of the art. Conductor connection terminals are constantly being developed further in terms of their handling, possible applications, and production costs. Conductor connection terminals can be extended or improved in their functionality and/or handling by means of optional or supplementary accessory elements. Accessory elements can be, for example, additional components such as contact, test, or information elements, which are manufactured and available separately.

The accessory element can generally be permanently fastened to the conductor connection terminal. Depending on the example, the accessory element can also be detachably fastened to the conductor connection terminal, for example, by means of a positive and/or nonpositive mechanical connection. In the present application, a detachable fastening is understood to mean in particular a nondestructive detachable connection for repeatable connection and disconnection, in particular also a connection between an accessory element and conductor connection terminal that can be established and disconnected without tools. A permanent fastening of the accessory element to the conductor connection terminal can also take place without tools, for example, by means of a plug detent connection.

For the fastening of accessory elements, a connection option is usually provided on the conductor connection terminal by means of a dedicated fastening structure for the accessory element. In practice, such fastening structures can lead to increased material and manufacturing costs, particularly in the case of a high number of different accessory element variants, and can also require, for example, multiple fastening structures per conductor connection terminal or additional adapters, so that these requirements conflict with an uncomplicated design and use of the conductor connection terminal. At the same time, suitable accessory elements must also be available for different variants of conductor connection terminals.

### SUMMARY OF THE INVENTION

Against this background, the invention is based on the object of providing a set comprising a conductor connection terminal and an accessory element with a simplified structure of the conductor connection terminal and the accessory element and with a high compatibility of different types of conductor connection terminals as well with different types of accessory elements.

The object is achieved with a set comprising a conductor connection terminal and an accessory element. According to the invention, it is provided that the conductor connection terminal has, in addition to the conductor insertion channel, an accessory insertion channel, in which the accessory element can be selectively fastened with a fastening section of the accessory element.

In general, in the context of this application, the words “a/an”, unless expressly defined otherwise, are not to be understood as a numeral but as an indefinite article with the literal meaning of “at least one,” so that, for example, the accessory element can also be fastened to the conductor connection terminal with two or more fastening sections or the conductor connection terminal can have two or more accessory insertion channels.

A highly variable and versatile fastening option for accessory elements is provided with an accessory insertion channel; these elements have a fastening section that can be inserted into the accessory insertion channel and fastened in the accessory insertion channel. Simply by inserting the fastening section of the accessory element into the accessory insertion channel, the conductor connection terminal and accessory element can be held together and mechanically fixed by their interlocking without, for example, the need for an additional external fastening structure to secure the accessory element.

The fastening section of the accessory element and/or the conductor connection terminal can have a plug contour for fastening the fastening section in the accessory insertion channel.

A plug contour can be understood to mean a geometric shape that enables, facilitates, or improves insertion of the fastening section into the accessory insertion channel and/or holding of the fastening section in the accessory insertion channel.

The plug contour can have or form a pluggable geometric basic shape or a pluggable geometric basic channel shape. The plug contour of the fastening section is formed, for example, by a plug-like basic plug shape of the fastening section, such as an elongated rod- or strip-shaped, cylindrical or cuboidal plug shape or a plug shape that is rectangular, trapezoidal, or stepped in cross section or even round, and which can be straight or conically tapered as well.

The plug contour of the conductor connection terminal can, for example, be formed by a socket-like basic channel shape of the accessory insertion channel, a shape which may also correspond to the geometric basic plug shape of the fastening section, such as an elongated tubular or slot-shaped, cylindrical or cuboidal basic channel shape or a basic channel shape that is rectangular, trapezoidal, stepped in cross section or even round, and which may be straight or, for example, conically tapered as well.

As an alternative or in addition to a pluggable geometric basic shape, the plug contour can also have or form a fastener, for example, a lock such as a locking arm, a locking edge, a locking lug, or a locking shoulder, wherein the lock can also be designed to be resilient, for example. The plug contour can also have or form a spring element such as a spring fork or a spring tongue. The plug contour can also have or form a projection, a stop, a contact shoulder, or a recess, a toothed or corrugated structure or a functional surface such as a contact or guide surface, which enable or facilitate the insertion or holding of the fastening section in the accessory insertion channel. The plug contour can also form a guide contour such as, for example, a groove guide or a guide pin.

Depending on the design of the plug contour and/or the fastener, a permanent or detachable fastening of the accessory element to the conductor connection terminal may be possible. For example, an elastic locking lug or a small undercut of the locking lug with a locking edge can lead to a detachable fastening, whereas a comparatively rigid locking lug or a comparatively large undercut of the locking lug with a locking edge can enable a permanent fastening.

The plug contour of the conductor connection terminal can be present on the accessory insertion channel and, for example, be molded or formed on its channel wall. However, it is also conceivable that the plug contour is present on another component of the conductor connection terminal, for example, on a busbar provided for the conductor connection in the conductor connection terminal.

It is also conceivable, for example, that the accessory insertion channel opens out at a busbar provided for the conductor connection in the conductor connection terminal or that the busbar protrudes into the accessory insertion channel in sections and that the busbar has or forms a plug contour in this area. A plug contour of the busbar can be designed in the form of a contact slot, for example, into which a plug contour of the fastening section can be received. A plug contour on the busbar is also suitable, for example, for accessory elements that are designed as electrical contact elements and can be electrically connected to the busbar. However, accessory elements that are designed differently and are not formed as electrical contact elements can also protrude with a fastening section into the busbar plug contour, for example, made as a contact slot, and be mechanically supported on it. This can reliably prevent the accessory element inserted into the accessory insertion channel from tilting, wobbling, or swinging movements and the accessory element can be held securely in the conductor connection terminal. Insertion and fixation of the accessory element in the conductor connection terminal are possible simply and securely in a variety of individual ways with the plug contours described above.

If the fastening section of the accessory element and the conductor connection terminal each have at least one plug contour, these plug contours can be designed to correspond to each other. Corresponding here means in particular that the plug contour of the fastening section is compatible with the plug contour of the conductor connection terminal and interacts mechanically with it, for example, can form a positive and/or nonpositive connection.

Mutually corresponding plug contours can also be regarded as a plug contour with a mating plug contour corresponding thereto. For example, the plug contour can be a locking contour such as a locking lug, which interacts with a corresponding mating plug contour such as a locking edge.

Mutually corresponding plug contours can also have mutually compatible positive and negative shapes, for example, wherein a positive form is connected to a material addition such as a pin or a projection and a negative form is connected to a corresponding material cutout such as a hole, recess, or groove, so that the positive form and the negative form can geometrically interlock. The hold of the accessory element in the conductor connection terminal can be improved by mutually corresponding plug contours.

The plug contour can be formed from a predominantly electrically conductive material, for example, a metal, or from a predominantly electrically nonconductive material, for example, a plastic. Plug contours with predominantly electrically conductive materials can be present, for example, on the busbar or on a plug tongue of the accessory element and, for example, also simultaneously fulfill electrical contacting functions, whereas plug contours with predominantly electrically nonconductive materials can, for example, be part of an insulating material housing of the conductor connection terminal or the accessory element and are only provided for a mechanical fixation of the accessory element to the conductor connection terminal.

It is conceivable that the fastening section of the accessory element and/or the conductor connection terminal have at least one plug contour made predominantly of electrically conductive material and at least one plug contour made predominantly of electrically nonconductive material. For example, a metallic plug tongue of an accessory element with a plug contour can have an insulating material sleeve in sections, which in turn has or forms a plug contour, and, for example, an associated conductor connection terminal can have a metallic busbar with a mating plug contour for the metallic plug tongue of the accessory element and an accessory insertion channel with channel walls made of insulating material with a mating plug contour for the insulating material sleeve of the accessory element.

The fastening section of the accessory element can be at least partially elastically deformable. For example, the fastening section can be designed as a spring element or have a spring element such as a spring tongue or a spring fork. The fastening section of the accessory element can rest against the inside of the accessory insertion channel or another component of the conductor connection terminal, such as a busbar, for example, under spring force due to an elastically deformable spring element, so that a secure hold of the accessory element in the conductor connection terminal is ensured.

The spring element can be formed, for example, as a spring fork with spring arms, running parallel to each other, in order to enable symmetrical force transmission into the accessory insertion channel or, for example, into a busbar onto which the spring fork can be attached or into which the spring fork can be inserted. If the accessory element is designed as an electrical contact element, this also improves the electrical contact between the busbar and accessory element.

The conductor connection terminal can have an insulating material housing. The insulating material housing can have a top side to which, for example, an actuating element such as an actuating lever of the conductor connection terminal can be assigned.

The insulating material housing can have a bottom side which is opposite the top side and can, for example, form a supporting surface for the conductor connection terminal. The top side and bottom side of the insulating material housing can be connected to each other by housing side walls.

The accessory insertion channel can have an accessory insertion opening. The accessory insertion channel can open out at the accessory insertion opening on a side wall of the housing of the conductor connection terminal. The fastening section of the accessory element can be inserted into the accessory insertion channel through the accessory insertion opening.

The conductor insertion channel of the conductor connection terminal can have a conductor insertion opening. The conductor insertion channel can open out at the conductor insertion opening on a side wall of the housing of the conductor connection terminal. An electrical conductor provided for connection in the conductor connection terminal can be inserted into the conductor insertion channel through the conductor insertion opening. The accessory insertion opening can be arranged in the same housing side wall as a conductor insertion opening of the conductor connection terminal. This improves the accessibility and thus the ease of use of the conductor connection terminal with the accessory element. The accessory insertion opening and the conductor insertion opening can lie in a mutual plane.

The accessory insertion opening can be located in the housing side wall closer to the bottom side of the insulating material housing than the conductor insertion opening. The accessory insertion opening can therefore be located below the conductor insertion opening in relation to the bottom side of the insulating material housing of the conductor connection terminal, which side is designed, for example, as the supporting surface of the conductor connection terminal. It can be ensured hereby that the insertion of electrical conductors into the conductor connection terminal is not disturbed or hindered by an accessory element fastened to the conductor connection terminal.

The conductor insertion channel, when viewed in an insertion direction of the electrical conductor, can extend substantially parallel to the accessory insertion channel in an insertion direction of the fastening section of the accessory element. The insertion directions of the electrical conductor and the fastening section of the accessory element can be parallel to each other and aligned in the direction of a conductor connection space inside the conductor connection terminal. A central longitudinal axis of the accessory insertion channel can extend parallel to a central longitudinal axis of the conductor insertion channel. However, examples are also conceivable in which the accessory insertion channel and the conductor insertion channel are at an imaginary angle to each other or run at an angle to each other, wherein the angle can be between 0 and 900.

The accessory insertion channel can have a smaller cross section than the conductor insertion channel. A smaller cross section can be understood in particular as a smaller cross-sectional area, which results from a smaller diameter or a smaller width or height with the same or smaller width or height. An accessory insertion opening assigned to the accessory insertion channel can also have a smaller cross section than a conductor insertion opening assigned to the conductor insertion channel. This makes it easier for the user to visually identify into which opening or channel an electrical conductor or a fastening section of an accessory element is to be inserted.

The accessory insertion channel can have a substantially rectangular, trapezoidal, stepped, or also round cross section. The accessory insertion channel can open out into a substantially rectangular or round accessory insertion opening. The specific design of the conductor insertion opening and the accessory insertion opening or the respective associated channels can also be based on optical or mechanical coding aspects, so that inserting and/or holding an electrical conductor only in the conductor insertion channel and inserting and/or holding a fastening section of an accessory element only in the accessory insertion channel are exemplified or technically possible. The optical coding can be carried out, for example, by a colored marking provided on a fastening section of an accessory element and on an accessory insertion opening. A mechanical coding can also occur, for example, via different geometric cross-sectional shapes of the accessory insertion opening and the conductor insertion opening.

The set can have multiple conductor connection terminals that can be arranged in series. Arranged in series can mean, for example, that conductor connection terminals can be arranged adjacent or contiguous to one another. In this case, the conductor connection terminals can be arranged in series in such a way that they abut each other with housing side walls that do not have a conductor insertion opening. The conductor connection terminals that can be arranged in series can have a similar or identical structure or also similar or identical dimensions. In principle, however, series arrangements with conductor connection terminals of different structures or dimensions are also conceivable.

The distance between two opposite housing side walls of the insulating material housing of the conductor connection terminal, which do not have a conductor insertion opening, is referred to in particular as the width of the conductor connection terminal. The dimension of an accessory element which is fastened to the conductor connection terminal and extends parallel to the width of the conductor connection terminal, is referred to in particular as the width of the accessory element.

The accessory element can have a smaller, equal, or greater width than the conductor connection terminal. If multiple conductor connection terminals are arranged in series and an accessory element with a width greater than the width of a single conductor connection terminal extends parallel to these conductor connection terminals, the accessory element can be fastened with a fastening section in at least one accessory insertion channel of one of the conductor connection terminals.

It is also conceivable that the accessory element has a plurality of fastening sections spaced apart in such a way that the fastening sections can each be inserted into an accessory insertion channel of a conductor connection terminal or at least into multiple accessory insertion channels of conductor connection terminals arranged in series. In this case, the distance between the fastening sections can substantially correspond to a distance or multiples of the distance between accessory insertion channels of conductor connection terminals arranged in series. In this way, an accessory element with fastening sections can be inserted into accessory insertion channels of conductor connection terminals arranged in series and fastened there. This is advantageous, for example, if the accessory element is a jumper or a strain relief unit that is provided or advantageous for use on conductor connection terminals arranged in series.

One or more fastening sections can have a smaller cross section than the respectively associated accessory insertion channels. This enables greater manufacturing tolerances and improved compatibility with different variants of conductor connection terminals and accessory elements. In particular, accessory elements can be manufactured in this way as identical parts for different variants of conductor connection terminals. The possibly initially reduced hold of a fastening section with a smaller cross section in the associated accessory insertion channel can be eliminated by an additional plug contour such as a locking lug on the fastening section or also by the fact that the distances between the fastening sections are dimensioned in such a way that the fastening sections can be supported on different accessory insertion channel areas on the conductor connection terminal. This creates a positive and/or nonpositive connection across multiple conductor connection terminals. For example, in the case of two fastening sections in two conductor connection terminals, one fastening section can rest against a left edge area of the accessory insertion channel assigned to it and the other fastening section against a right edge area opposite the left edge area of the accessory insertion channel assigned to it, or vice versa. This limits one degree of freedom of the fastening section in such a way that a joint positive and/or nonpositive connection at the conductor connection terminals is created due to the interaction of the fastening sections inserted into an accessory insertion channel. If the fastening sections are designed to be elastically deformable, the support of the same can be further improved, even across multiple conductor connection terminals, and the holding or spring forces of the fastening sections can be increased.

As already described above, the conductor connection terminal can have a busbar. Depending on the example and the type of accessory element, the accessory element fastening section inserted into the accessory insertion channel can end before the busbar, end at the busbar, or be fixed to a plug contour of the busbar. For example, an accessory element designed as an information carrier has a fastening section of such a length that it does not reach the busbar when inserted into the accessory insertion channel, whereas an accessory element designed as a jumper has a fastening section of such a length that it can be fixed to a plug contour of the busbar. However, it is also conceivable that an accessory element designed as an information carrier has a fastening section of such a length that it can be fixed to a plug contour of the busbar in order to be held even more securely in the accessory insertion channel. In contrast, an accessory element designed as a test element, for example, can have a fastening section of such a length that it ends at the busbar without having to be mechanically fixable to the same.

Depending on the example and depending on the type of accessory element, the fastening section can be a mechanical fastening section or an electromechanical fastening section with an electrical contact. As an electromechanical fastening section, the fastening section also fulfills electrical contacting functions and can establish an electrical connection to the busbar, for instance, also between two or more conductor connection terminals arranged in series.

The accessory element can be, for example, a strain relief unit. A strain relief unit is used to relieve the strain on an electrical conductor connected to the conductor connection terminal and can, for example, be designed as a strain relief plate with fastener or feed-through openings for electrical conductors. Accessory elements designed as strain relief units can be fastened, in particular, permanently to the conductor connection terminal, wherein a detachable fastening to the conductor connection terminal for strain relief units is not excluded.

The accessory element can be, for example, an information carrier such as a marker carrier or label carrier. An information carrier is used, for example, for the written assignment of a connected electrical conductor. Accessory elements designed as information carriers can be fastened, in particular, detachably to the conductor connection terminal, wherein a permanent fastening to the conductor connection terminal for information carriers is not excluded.

The accessory element can be a contact element, for example, a jumper or a PE contact. Such a contact element is used to establish an electrical connection between conductor connection terminals or to provide protective earthing. Accessory elements designed as jumpers can be fastened, in particular detachably, to the conductor connection terminal, wherein a permanent fastening to the conductor connection terminal for jumpers is not excluded. Accessory elements designed as PE contacts can be fastened, in particular permanently, to the conductor connection terminal, wherein a detachable fastening to the conductor connection terminal for PE contacts is not excluded.

Depending on the type of accessory element, the strain relief unit can have one fastening section for fastening to a conductor connection terminal or multiple fastening sections for fastening to one or more conductor connection terminals arranged in series.

It is also conceivable that the accessory element can also fulfill multiple accessory functions; for example, the accessory element can be a strain relief unit and an information carrier at the same time.

The set can also have multiple identical or different conductor connection terminals and also multiple identical or different accessory elements, so that different predefined conductor connection terminal/accessory combinations can be put together depending on the product solution and area of application.

The set can have an adapter part with a fastening section, wherein an accessory element without a fastening section or an accessory element with an incompatible fastening section can be indirectly fastened in the accessory insertion channel of the conductor connection terminal using the adapter part. The adapter part can be used to retrofit existing accessory elements for the set of the invention, so that accessory elements that already exist but are incompatible with the conductor connection terminal, can nevertheless be fastened to the conductor connection terminal.

The accessory element can be detachably fastened to the conductor connection terminal, for example, by means of a positive and/or nonpositive mechanical connection. In the present application, a detachable fastening is understood to mean in particular a nondestructive detachable connection for repeatable connection and disconnection, in particular also a connection between an accessory element and conductor connection terminal that can be established and disconnected without tools.

The conductor connection terminal can have two or more accessory insertion channels. In the case of multiple accessory insertion channels, these can be located, for example, on the same side or side wall of the conductor connection terminal or on different, for example, opposite, sides or side walls of the conductor connection terminal. Multiple accessory insertion channels of a conductor connection terminal can, for example, lie substantially opposite each other and run facing each other or extend parallel to each other. The same or different accessory elements can be inserted into multiple accessory insertion channels so that, for example, bridging chains can be realized via multiple conductor connection terminals using accessory elements designed as jumpers or an accessory element designed as an information carrier can be inserted into an accessory insertion channel on one side of the conductor connection terminal and an accessory element designed as a jumper can be inserted into another accessory insertion channel on the opposite side of the conductor connection terminal. An accessory element designed as a strain relief element, for example, can also be inserted into accessory insertion channels facing each other on opposite sides of the conductor connection terminal.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1a shows two conductor connection terminals with a fastened accessory element according to an example in a perspective view;

FIG. 1b shows the accessory element according to an example in a perspective view;

FIG. 1c shows the conductor connection terminals, shown in FIG. 1a, with the fastened accessory element according to an example in a sectional bottom view;

FIG. 1d shows one of the conduct or connection terminals, shown in FIG. 1a, with the fastened accessory element according to an example in a sectional side view;

FIG. 2a shows six conductor connection terminals with two fastened accessory elements according to an example in a perspective view;

FIG. 2b shows an accessory element according to an example in a perspective view;

FIG. 2c shows three of the conductor connection terminals, shown in FIG. 2a, with the fastened accessory element according to an example in a sectional bottom view;

FIG. 2d shows one of the conductor connection terminals, shown in FIG. 2a, with the fastened accessory element according to an example in a sectional side view;

FIG. 3a shows two conductor connection terminals with a fastened accessory element according to an example in a perspective view;

FIG. 3b shows the accessory element according to an example in a perspective view;

FIG. 3c shows the conductor connection terminals, shown in FIG. 3a, with the fastened accessory element according to an example in a side view;

FIG. 3d shows the conductor connection terminals, shown in FIG. 3a, with the fastened accessory element according to an example in a sectional bottom view;

FIG. 3e shows one of the conductor connection terminals, shown in FIG. 3a, with the fastened accessory element according to an example in a sectional side view;

FIG. 4a shows four conductor connection terminals with two fastened accessory elements according to an example in a perspective view;

FIG. 4b shows the accessory element according to an example in a perspective view;

FIG. 4c shows the accessory element inserted into two busbars of the conductor connection terminals according to an example in a perspective view;

FIG. 4d shows one of the conductor connection terminals, shown in FIG. 4a, with the fastened accessory element according to an example in a sectional side view;

FIG. 5a shows two conductor connection terminals with a fastened accessory element according to an example in a perspective view;

FIG. 5b shows the accessory element according to an example in a perspective view;

FIG. 5c shows the accessory element inserted into a busbar of the conductor connection terminal according to an example in a perspective view;

FIG. 5d shows the conductor connection terminals, shown in FIG. 5a, with the fastened accessory element according to an example in a sectional bottom view;

FIG. 5e shows one of the conductor connection terminals, shown in FIG. 5a, with the fastened accessory element according to an example in a sectional side view;

FIG. 6a shows two conductor connection terminals with a fastened accessory element according to an example in a perspective view;

FIG. 6b shows the accessory element according to an example in a perspective view;

FIG. 6c shows the accessory element inserted into a busbar of the conductor connection terminal according to an example in a perspective view;

FIG. 6d shows the conductor connection terminals, shown in FIG. 6a, with the fastened accessory element according to an example in a perspective bottom view;

FIG. 6e shows the conductor connection terminals, shown in FIG. 6a, with the fastened accessory element according to an example in a sectional bottom view;

FIG. 6f shows one of the conductor connection terminals, shown in FIG. 6a, with the fastened accessory element according to an example in a sectional side view.

### DETAILED DESCRIPTION

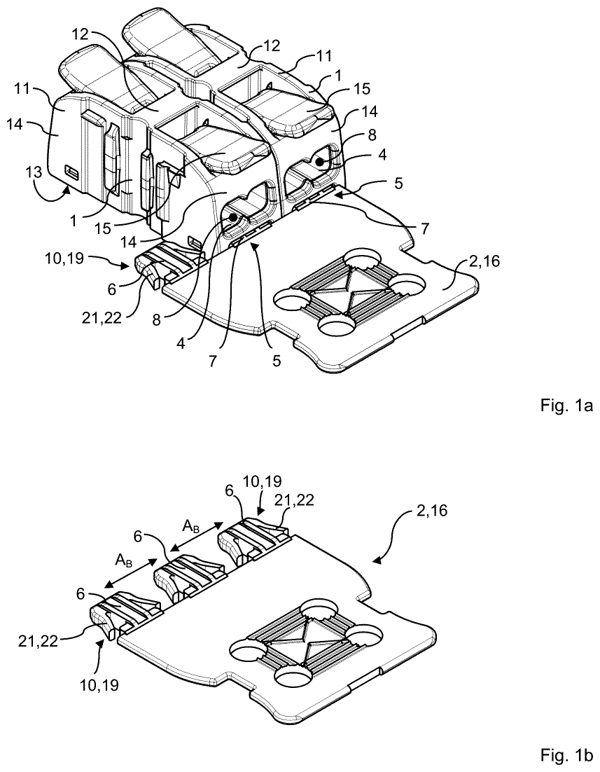

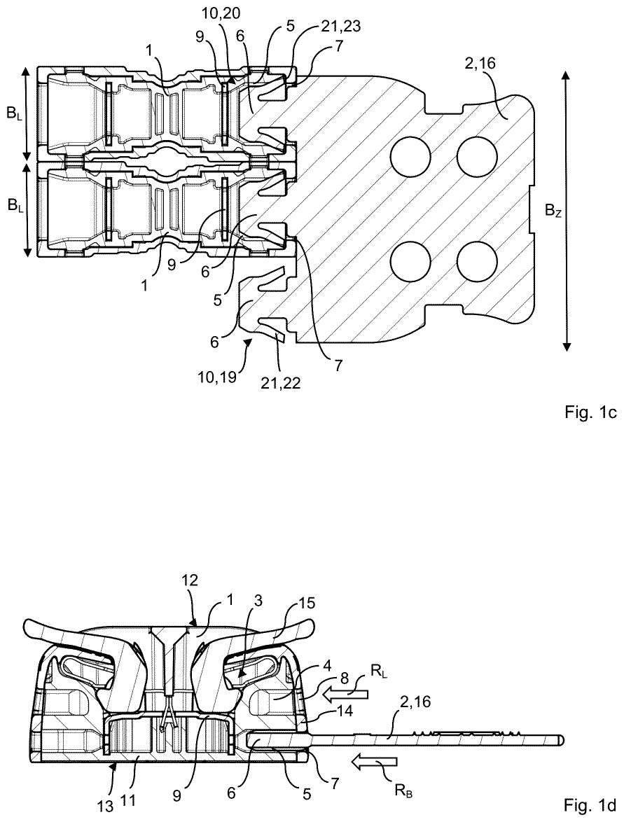

FIGS. 1a to 6f show sets of the invention with conductor connection terminals 1 and accessory elements 2 according to different examples. All the depicted examples show sets with a plurality of conductor connection terminals 1 for better illustration, wherein the invention can also be realized with only one conductor connection terminal 1. The figures show conductor connection terminals 1 arranged in a regular manner in series; in other words, they are arranged contiguously next to one another and can be mechanically connected to one another by connector(s). Conductor connection terminals 1 selected for the examples are designed as symmetrically constructed double terminals with conductor connections 3 which are mutually opposite in the conductor insertion direction R_{L} and are shown in FIGS. 1d, 2d, 3e, 4d, 5e, and 6f, mutually opposite conductor insertion channels 4 facing each other, and mutually opposite accessory insertion channels 5 facing each other. Conductor connections 3 are used for the electrical connection of an electrical conductor to a busbar 9. For reasons of clarity, reference numbers are predominantly only shown for the symmetry halves of conductor connection terminals 1 to which an accessory element 2 is fastened.

Conductor connection terminals 1 have an insulating material housing 11 to protect conductor connections 3 from environmental influences and as contact protection for a user of conductor connection terminals 1. Insulating material housing 11 has a top side 12 on which, for example, actuating levers 15 can be located, each of which is assigned to a conductor connection 3 of conductor connection terminals 1 and can serve to actuate a clamping spring of conductor connections 3 designed as a clamping spring connection in the examples. Insulating material housing 11 has a bottom side 13 which can form a supporting surface for conductor connection terminal 1. Bottom side 13 lies opposite top side 12. Top side 12 and bottom side 13 of insulating material housing 11 are connected to each other by housing side walls 14. On housing side wall 14, which is provided for inserting electrical conductors into conductor connection terminal 1 to conductor connection 3, conductor insertion openings 8 are provided to which a conductor insertion channel 4 is connected. In the examples presented, accessory insertion openings 7, to each of which accessory insertion channel 5 is connected, are provided on the same housing side wall 14 on which conductor insertion openings 8 are present. A fastening section 6 of an accessory element 2 can be inserted into accessory insertion openings 7 and into adjoining accessory insertion channel 5 and fastened therein.

Accessory insertion openings 7 are located closer to bottom side 13 of insulating material housing 11 than conductor insertion openings 8. Conductor insertion channel 4, when viewed in an insertion direction R_{L} of the electrical conductor, extends substantially parallel to accessory insertion channel 5 in an insertion direction R_{B} of fastening section 6 of accessory element 2, as can be seen, for example, in FIGS. 1d, 2d, 3e, 4d, 5e, and 6f. The insertion directions R_{L} and R_{B} of the electrical conductor and of fastening section 6 are parallel and oriented in the same direction in the examples shown.

FIGS. 1a to 1d show a set of the invention in accordance with a first example. FIG. 1a shows two conductor connection terminals 1, in which an accessory element 2 is fastened. Conductor connection terminals 1 have similar dimensions and are arranged in series. In the variant of conductor connection terminals 1 shown in FIGS. 1a to 1d, the cross section of conductor insertion openings 8 and conductor insertion channels 5 is dimensioned and designed such that two electrical conductors can be inserted into conductor connection terminal 1 side by side.

According to the first example shown as an example in FIGS. 1a to 1d, accessory element 2 is a strain relief unit 16. Strain relief unit 16 is used to relieve the strain on electrical conductors connected to conductor connections 3 and, in the present case, is designed as a strain relief plate with feed-through openings for cable ties or the like to be fastened, for example. As is evident in FIG. 1c, the width Bz of accessory element 2 formed as a strain relief unit 16 can be greater than the width BL of a single conductor connection terminal 1. Accessory element 2 extends parallel to conductor connection terminals 1 arranged in series. Strain relief unit 16 has multiple, according to the example three, fastening sections 6, which can be inserted into accessory insertion channels 5 of conductor connection terminals 1, arranged in series, and fastened there, as this is shown in FIGS. 1a and 1c as an example for two conductor connection terminals 1 arranged in series. As shown in FIG. 1b, fastening sections 6 have such a distance AB from each other that they are compatible with conductor connection terminals 1, which can be arranged in series, with their respective accessory insertion channels 5; therefore, they project from strain relief unit 16 at a distance AB that essentially corresponds to the distance between accessory insertion channels 5 of conductor connection terminals 1 arranged in series.

As is evident in FIG. 1c, for example, fastening sections 6 have a plug contour 10 with a basic plug shape 19 that is substantially trapezoidal in cross section, and accessory insertion channels 5 have a basic channel shape 20 that corresponds to the trapezoidal basic plug shape 19 of fastening sections 6, is stepped and, depending on the step, is rectangular or trapezoidal in cross section, and has a number of shoulders against which basic plug shape 19 of fastening sections 6 can rest. As is evident in FIG. 1b, fastening sections 6 furthermore each have two resilient locking arms 22, which project from the respective fastening section 6 on mutually opposite sides of fastening section 6 from a fastening side wall of fastening section 6. A fastening side wall of fastening section 6 is a surface of fastening section 6 that connects an upper fastening side, which faces a top side 12 of insulating material housing 11 of conductor connection terminal 1 in a fastened state of fastening section 6 in conductor connection terminal 1, and a lower fastening side, which faces a bottom side 13 of insulating material housing 11 of conductor connection terminal 1 in a fastened state of fastening section 6 in conductor connection terminal 1.

Locking arms 22 form a fastener 21 of fastening section 6. Fastening sections 6 are partially elastically deformable in the area of their resilient locking arms 22. After fastening section 6 has been inserted into accessory insertion channel 5, the resilient locking arms 22 engage behind a fastener 21, formed as a locking edge 23 and corresponding to a locking arm 22, and rest against the channel walls of accessory insertion channel 5. Due to basic plug shape 19, which is trapezoidal in cross section, with the corresponding stepped basic channel shape 20 and the additional fastener 21 as locking arms 22 of fastening section 6 and as locking edge 23 of accessory insertion channel 5, strain relief unit 16 inserted into conductor connection terminal 1 with fastening sections 6 is intuitively connected to conductor connection terminal 1 and held securely there. Removal of accessory element 2, formed as a strain relief unit, from accessory insertion channel 5 is not provided for in this example, but is not excluded in principle for accessory elements 2 formed as strain relief units.

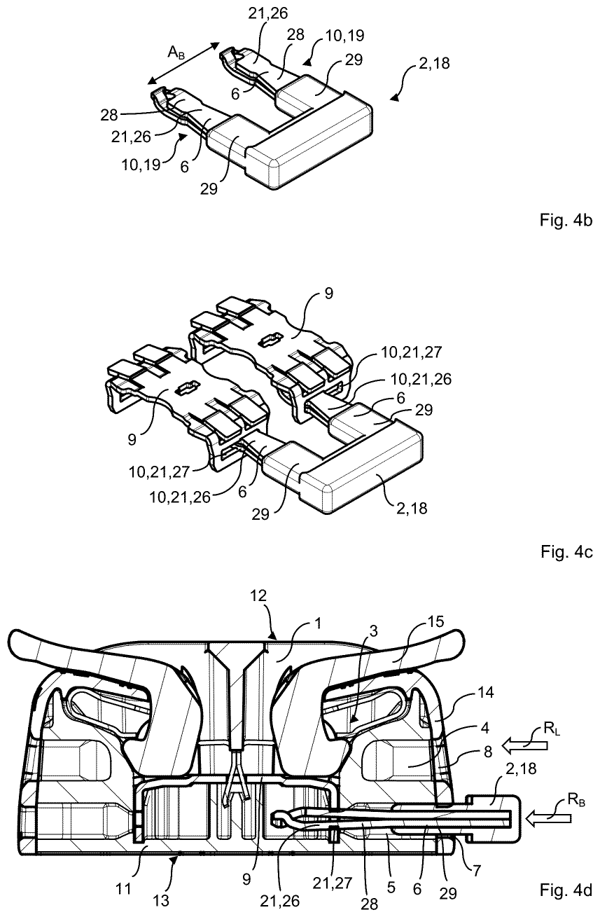

In the example according to the first example shown in FIGS. 1a to 1d, plug contours 10 of accessory element 2 are formed from a predominantly electrically nonconductive material, in particular an insulating material such as a plastic, for example. Strain relief unit 16 is thus fastened to conductor connection terminal 1 purely mechanically, without fulfilling any additional electrical contact functions. As is evident in FIG. 1c, fastening sections 6 end spatially before busbar 9, when viewed in the direction of insertion R_{B} into accessory insertion channel 5, and do not touch it. Alternatively, fastening sections 6 could also be extended, however, in such a way that a section of fastening sections 6 projects into a contact slot 27 of busbar 9 and is additionally fixed there, as depicted, for example, for an accessory element 2 formed as a jumper and shown in FIG. 4c.

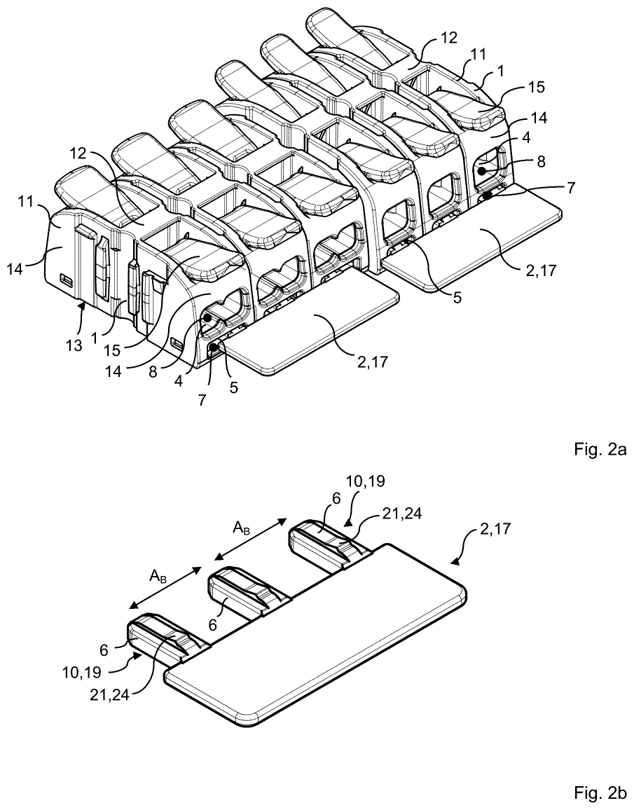

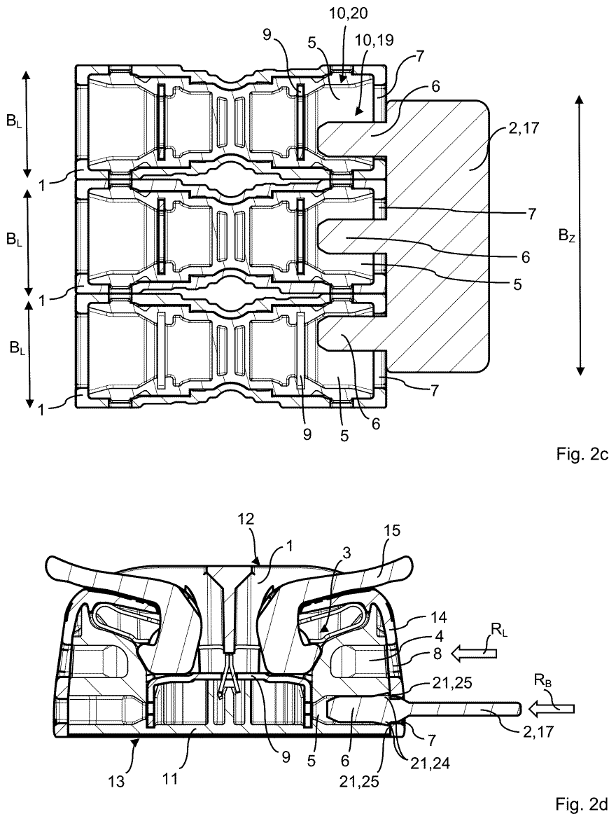

FIGS. 2a to 2d show a set of the invention in accordance with a second example. FIG. 2a shows six conductor connection terminals 1, of which three conductor connection terminals 1 have similar dimensions and differ from the other three conductor connection terminals 1. A common accessory element 2 is detachably fastened in each of the three similar conductor connection terminals 1 arranged in series. In the variants of conductor connection terminals 1 shown in FIG. 2a, conductor insertion openings 8 and conductor insertion channels 5 of the three conductor connection terminals 1 shown in the figure at the front, therefore, facing the observer, are dimensioned and designed in their cross section such that two electrical conductors can be inserted into the front conductor connection terminals 1 side by side. The three conductor connection terminals 1 at the rear in the illustration, therefore, facing away from the observer, are made narrower and have conductor insertion openings 8 and conductor insertion channels 5, which are more intended or suitable in their cross section for receiving a single electrical conductor.

According to the second example shown as an example in FIGS. 2a to 2d, accessory element 2 is an information carrier 17, which is provided as a common labeling carrier for three conductor connection terminals 1 arranged in series. Information carrier 17 is used, for example, for a written assignment of connected electrical conductors.

As is evident in FIG. 2c, the width Bz of accessory element 2 formed as an information carrier 17 can be greater than the width BL of a single conductor connection terminal 1. Accessory element 2 extends parallel to conductor connection terminals 1 arranged in series. Information carrier 17 has multiple, according to the example three, fastening sections 6, which can be inserted into accessory insertion channels 5 of conductor connection terminals 1, arranged in series, and fastened there, as this is shown in FIGS. 2a and 2c as an example for three conductor connection terminals 1 arranged in series.

As shown in FIG. 2b, fastening sections 6 have such a distance AB from each other that they are compatible with conductor connection terminals 1, which can be arranged in series, with their respective accessory insertion channels 5; therefore, they project from information carrier 17 at a distance AB that essentially corresponds to the distance between accessory insertion channels 5 of conductor connection terminals 1 arranged in series. In relation to conductor connection terminals 1 shown at the rear in FIG. 2a, fastening sections 6 of accessory element 2 have a cross section comparable to the associated accessory insertion channels 5. In relation to conductor connection terminals 1 shown at the front in FIG. 2a, fastening sections 6 of accessory element 2 have a smaller cross section than the associated accessory insertion channels 5. Due to this design of fastening sections 6, information carriers 17 shown in FIG. 2a are compatible with both variants of conductor connection terminals 1 despite their identical parts. In FIG. 2c, which shows a bottom view in cross section of the front conductor connection terminals 1 shown in FIG. 2a, it is clear that fastening sections 6 are supported on different accessory insertion channel areas of conductor connection terminal 1. This creates a positive and/or nonpositive connection across the three conductor connection terminals 1, which ensures a sufficient hold of fastening sections 6 in accessory insertion channels 5. Furthermore, the hold of fastening sections 6 in accessory insertion channels 5 is improved by additional plug contours 10 in the form of locking lugs 24 as fastener 21, which can engage behind an additional plug contour 10 in the form of a locking shoulder 25 as fastener 21 of accessory insertion channel 5.

As is evident in FIG. 2c, for example, fastening sections 6 have a plug contour 10 with a basic plug shape 19 that is substantially rectangular in cross section, and accessory insertion channels 5 have a basic channel shape 20 that corresponds to the rectangular basic plug shape 19 of fastening sections 6, is stepped and, depending on the step, is rectangular or trapezoidal in cross section, and has a number of shoulders against which basic plug shape 19 of fastening sections 6 can rest.

As is evident in FIGS. 2b and 2d, fastening sections 6 furthermore each have locking lugs 24, which project from the respective fastening section 6 on a fastening top side, which faces top side 12 of insulating material housing 11 in a fastened state of accessory element 2 in conductor connection terminal 1, and on a fastening bottom side which is opposite the fastening top side and faces bottom side 13 of insulating material housing 11 in a fastened state of accessory element 2 in conductor connection terminal 1, as can be seen in particular in FIG. 2d. Fastening sections 6 can be partially elastically deformable in the area of their locking lugs 24. After fastening section 6 has been inserted into accessory insertion channel 5, locking lugs 24 engage behind a fastener 21 formed as a locking shoulder 25 and corresponding to a locking lug 24. Due to basic plug shape 19, which is rectangular in cross section, with the corresponding stepped basic channel shape 20 and the additional fastener 21 as locking lugs 24 of fastening section 6 and as locking shoulder 25 of accessory insertion channel 5, information carrier 17 inserted into conductor connection terminal 1 with fastening sections 6 is intuitively detachably connected to conductor connection terminal 1 and held securely there.

In the example according to the second example shown in FIGS. 2a to 2d, plug contours 10 of accessory element 2 are formed from a predominantly electrically nonconductive material, in particular an insulating material such as a plastic, for example. Information carrier 17 is thus fastened to conductor connection terminal 1 purely mechanically, without fulfilling any additional electrical contact functions. As is evident in FIG. 2c, for example, fastening sections 6 end spatially before busbar 9, when viewed in the direction of insertion R_{B} into accessory insertion channel 5, and do not touch it. Alternatively, fastening sections 6 could also be extended, however, in such a way that a section of fastening sections 6 projects into a contact slot 27 of busbar 9 and is additionally fixed there, as depicted, for example, for an accessory element 2 formed as a jumper and shown in FIG. 4c.

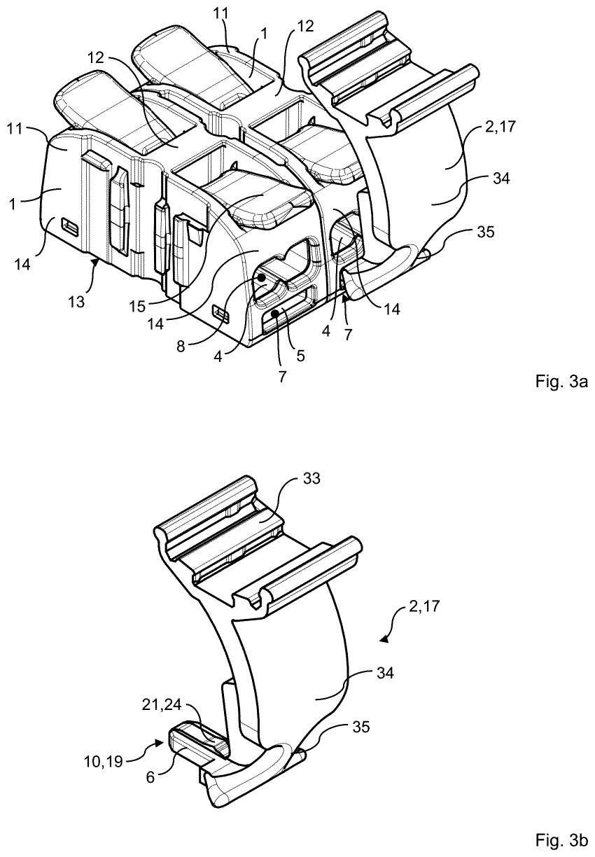

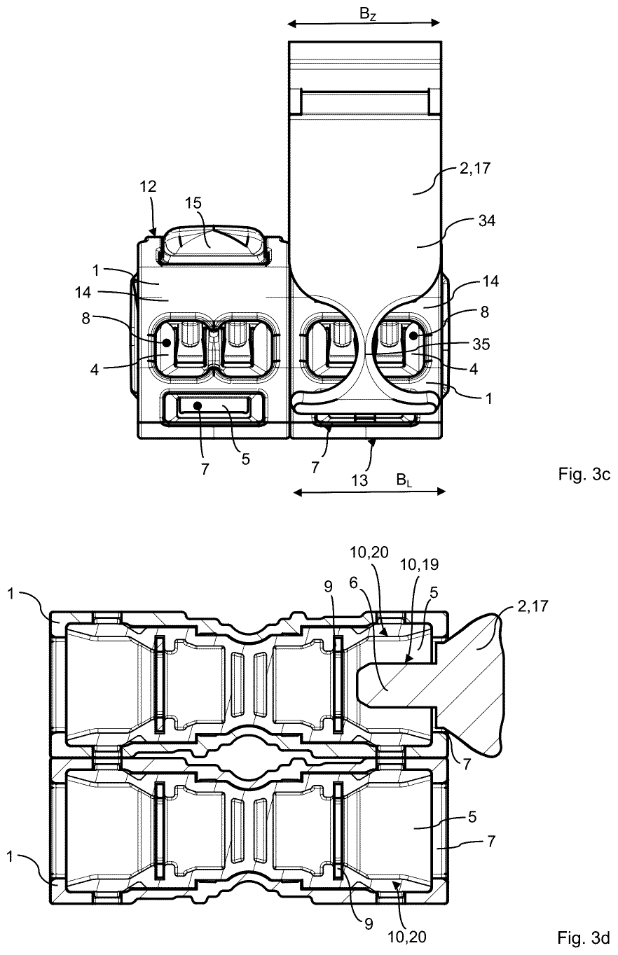

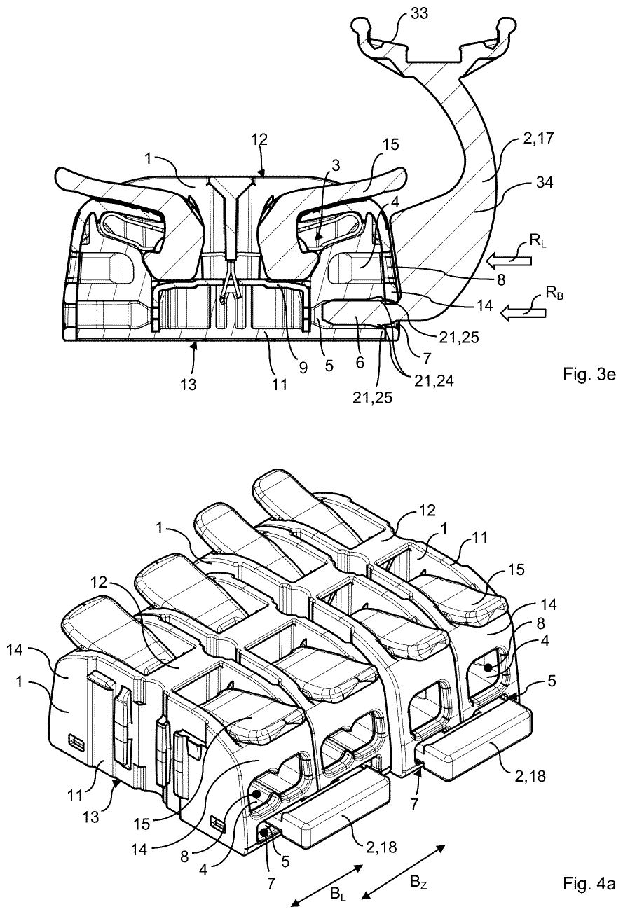

FIGS. 3a to 3e show a set of the invention in accordance with a third example. FIG. 3a shows two conductor connection terminals 1, wherein an accessory element 2 is detachably fastened to rear conductor connection terminal 1, facing away from the observer. Conductor connection terminals 1 have similar dimensions and are arranged in series. In the variant of conductor connection terminals 1 shown in FIGS. 3a to 3e, the cross section of conductor insertion openings 8 and conductor insertion channels 5 is dimensioned and designed such that two electrical conductors can be inserted into conductor connection terminal 1 side by side.

According to the third example shown as an example in FIGS. 3a to 3e, accessory element 2 is an information carrier 17, which is provided as an individual marker carrier for a conductor connection terminal 1. Information carrier 17 is used, for example, for a written assignment of connected electrical conductors.

As is evident in FIG. 3c, the width Bz of accessory element 2 designed as an information carrier 17 corresponds to the width BL of a single conductor connection terminal 1. Information carrier 17 has a fastening section 6 which is inserted into accessory insertion channel 5 of conductor connection terminal 1 and fastened there, as this is shown by way of example in FIGS. 3a and 3c to 3e. As is evident in FIG. 3d, fastening section 6 has a smaller cross section than the associated accessory insertion channel 5. Due to this design of fastening section 6, information carrier 17 shown in FIGS. 3a to 3e is compatible with a number of variants of conductor connection terminals 1, even if they have identical parts. The hold of fastening section 6 in accessory insertion channel 5 is ensured by an additional plug contour 10 in the form of a locking lug 24, which can engage behind an additional plug contour 10 of accessory insertion channel 5, said plug contour being formed as a locking shoulder 25. In addition, fastening sections 6 could also be extended, however, in such a way that a section of fastening sections 6 projects into a contact slot 27 of busbar 9 and is additionally fixed there, as depicted, for example, for an accessory element 2 formed as a jumper and shown in FIG. 4c.

As is evident in FIG. 3d, for example, fastening section 6 has a plug contour 10 with a basic plug shape 19 that is substantially rectangular in cross section, and accessory insertion channel 5 has a basic channel shape 20 that corresponds to the rectangular basic plug shape 19 of fastening section 6, is stepped and, depending on the step, is rectangular or trapezoidal in cross section, and has a number of shoulders against which the basic plug shape 19 of fastening section 6 can rest.

As is evident in FIGS. 3b and 3e, fastening section 6 furthermore has locking lugs 24, which project from the respective fastening section 6 on a fastening top side, which faces top side 12 of insulating material housing 11 in a fastened state of accessory element 2 in conductor connection terminal 1, and on a fastening bottom side which is opposite the fastening top side and faces bottom side 13 of insulating material housing 11 in a fastened state of accessory element 2 in conductor connection terminal 1, as can be seen in particular in FIG. 3e. Fastening section 6 can be partially elastically deformable in the area of its locking lug 24. After fastening section 6 has been inserted into accessory insertion channel 5, locking lug 24 engages behind a fastener 21 formed as a locking shoulder 25 and corresponding to a locking lug 24. Information carrier 17 inserted into conductor connection terminal 1 with fastening section 6 is intuitively and detachably connected to conductor connection terminal 1 by locking lug 24 and held securely there.

In the example according to the third example shown in FIGS. 3a to 3e, plug contours 10 of accessory element 2 of conductor connection terminal 1 are formed from a predominantly electrically nonconductive material, in particular an insulating material such as a plastic, for example. Information carrier 17 is thus fastened to conductor connection terminal 1 purely mechanically, without fulfilling any additional electrical contact functions. As is evident in FIG. 3d, for example, fastening sections 6 by way of example ends spatially before busbar 9, when viewed in the direction of insertion R_{B} into accessory insertion channel 5, and does not touch it. Alternatively, fastening section 6 could also be extended, however, in such a way that a section of fastening section 6 projects into a contact slot 27 of busbar 9 and is additionally fixed there, as depicted, for example, for an accessory element 2 formed as a jumper and shown in FIG. 4c.

Information carrier 17, in the example shown in FIGS. 3a to 3e, which is designed as a marker holder extends in its height from accessory insertion opening 7 over the entire housing side wall 14, having conductor insertion openings 8, and protrudes beyond the plane of top side 12, so that the marker receptacle 33 of information carrier 17 for the identification marker is located above top side 12 of connection terminal 1 when viewed in an insertion direction R_{L} of an electrical conductor into conductor connection terminal 1. When accessory element 2 is inserted, a connecting section 34 of information carrier 17 between fastening section 6 and marker receptacle 33 runs substantially parallel to housing side wall 14, at least in sections, and also in the area of conductor insertion openings 8. In order to prevent a covering or masking of conductor insertion openings 8 by information carrier 17 connected to conductor connection terminal 1, connecting section 34 has a constriction 35 formed by lateral cutouts lying opposite each other, which enable insertion of an electrical conductor past connecting section 34 into conductor insertion openings 8 in the area of the cutouts, therefore, on both sides of constriction 35. It can be clearly seen in FIG. 3c, for example, that constriction 35 of connecting section 34 in the area of conductor insertion openings 8 improves the accessibility of conductor insertion openings 8.

FIGS. 4a to 4d show a set of the invention in accordance with a fourth example. FIG. 4a shows four conductor connection terminals 1, of which two conductor connection terminals 1 have similar dimensions and differ from the other two conductor connection terminals 1. A common accessory element 2 is detachably fastened in each of the two similar conductor connection terminals 1 arranged in series. In the variants of conductor connection terminals 1 shown in FIG. 4a, conductor insertion openings 8 and conductor insertion channels 5 of the two conductor connection terminals 1 shown in the figure at the front, therefore, facing the observer, are dimensioned and designed in their cross section such that two electrical conductors can be inserted into the front conductor connection terminals 1 side by side. The two conductor connection terminals 1 at the rear in the illustration, therefore, facing away from the observer, are made narrower and have conductor insertion openings 8 and conductor insertion channels 5, which are more intended or suitable in their cross section for receiving a single electrical conductor.

According to the fourth example shown as an example in FIGS. 4a to 4d, accessory element 2 is a contact element 18, which is provided as a jumper for two conductor connection terminals 1 arranged in series. The jumper is used to establish an electrical connection between adjacent conductor connection terminals 1. As is evident in FIG. 4a, the width Bz of accessory element 2 formed as a contact element 18 is greater than the width BL of a single conductor connection terminal 1. Accessory element 2 extends parallel to conductor connection terminals 1 arranged in series. Contact element 18 has multiple, according to the example two, fastening sections 6, which can be inserted into accessory insertion channels 5 of conductor connection terminals 1, arranged in series, and fastened there, as this is shown in FIGS. 4a as an example. As shown in FIG. 4b, fastening sections 6 have such a distance AB from each other that they are compatible with conductor connection terminals 1, which can be arranged in series, with their respective accessory insertion channels 5; therefore, they project from contact element 18 at a distance AB that essentially corresponds to the distance between accessory insertion channels 5 of conductor connection terminals 1 arranged in series.

In relation to conductor connection terminals 1 shown at the rear in FIG. 4a, fastening sections 6 of accessory element 2 have a cross section comparable to the associated accessory insertion channels 5. In relation to conductor connection terminals 1 shown at the front in FIG. 4a, fastening sections 6 of accessory element 2 have a smaller cross section than the associated accessory insertion channels 5. Due to this design of fastening sections 6, contact elements 18 shown in FIG. 4a are compatible with both variants of conductor connection terminals 1 despite their identical parts. Fastening sections 6 can be supported hereby on different accessory insertion channel areas of conductor connection terminal 1.

In FIG. 4a, it can be seen here by way of suggestion in the case of the two front conductor connection terminals 1 that one fastening section 6 rests against a right edge area of the assigned accessory insertion channel 5 and the other fastening section 6 rests against a left edge area of the assigned accessory insertion channel 5. This creates a positive and/or nonpositive connection across the two conductor connection terminals 1, which ensures a sufficient hold of fastening sections 6 in accessory insertion channels 5. Furthermore, the hold of fastening sections 6 in accessory insertion channels 5 is improved by an additional plug contour 10 in the form of spring forks 26 as fastener 21, which can be inserted into contact slots 27 of busbar 9, said slots acting as fastener 21 and forming a plug contour 10, as shown in FIG. 4c, for example. It can be seen further in FIG. 4c that the spring forks 26 inserted into contact slots 27 can be supported on different edge areas of contact slots 27, so that the advantages of a high compatibility of different conductor connection terminals 1 or different busbars 9 of conductor connection terminals 1 with different accessory elements 2 result here as well.

Spring forks 26 are formed from a predominantly electrically conductive material, in particular from a metallic material. Fastening sections 6 according to the fourth example are therefore electromechanical fastening sections 6 with an electrical contact 28. In addition to the mechanical connection function, they also simultaneously fulfill electrical contacting functions of contact element 18. Spring forks 26 each formed of two spring arms arranged one above the other, whose respective spring force causes spring fork 26 to be pressed against the edge of contact slot 27 of busbar 9 for improved electrical contacting. Fastening section 6 is partially elastically deformable in the area of the spring arms. Spring fork 26 can also be referred to as the plug tongue of contact element 18. In this example, plug contour 10, corresponding to plug contour 10, formed as a spring fork 26, of fastening section 6, is not provided on accessory insertion channel 5, but on busbar 9 of conductor connection 3 of conductor connection terminal 1. This ensures a secure hold of fastening section 6 and a sufficient electrical contact between contact element 18 and busbar 9.

In addition to spring fork 26, fastening section 6 of contact element 18 has, in sections, an insulating material sleeve 29, which in turn forms a plug contour 10 and can come to rest in accessory insertion channel 5 of conductor connection terminal 1. Insulating material sleeve 29 can, for example, be substantially rectangular in cross section and thus form a rectangular basic plug shape 19 and be received in a positive and/or nonpositive manner in an accessory insertion channel 5 with a corresponding plug contour 10, for example, with a likewise rectangular cross section to form a rectangular basic channel shape 20.

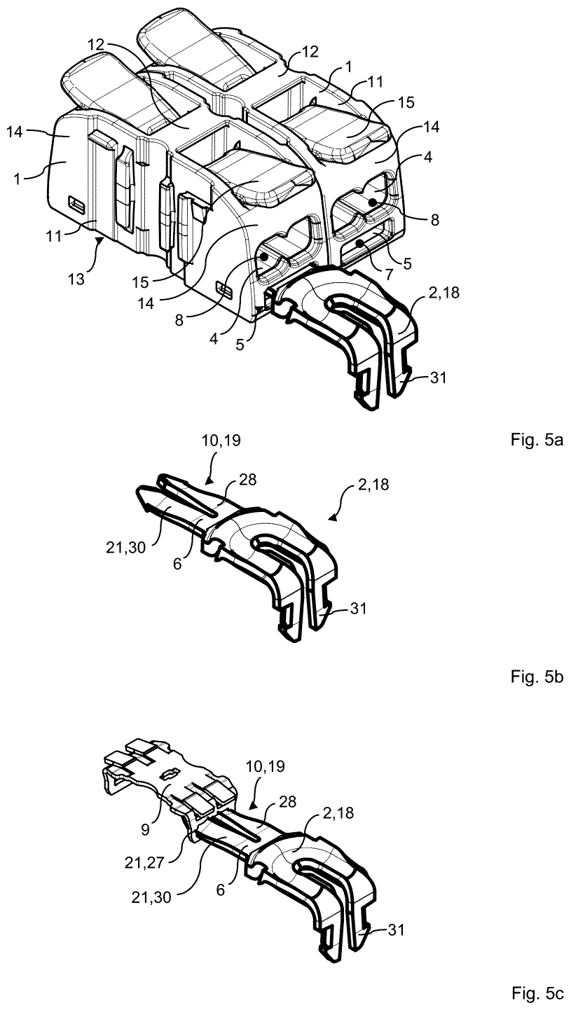

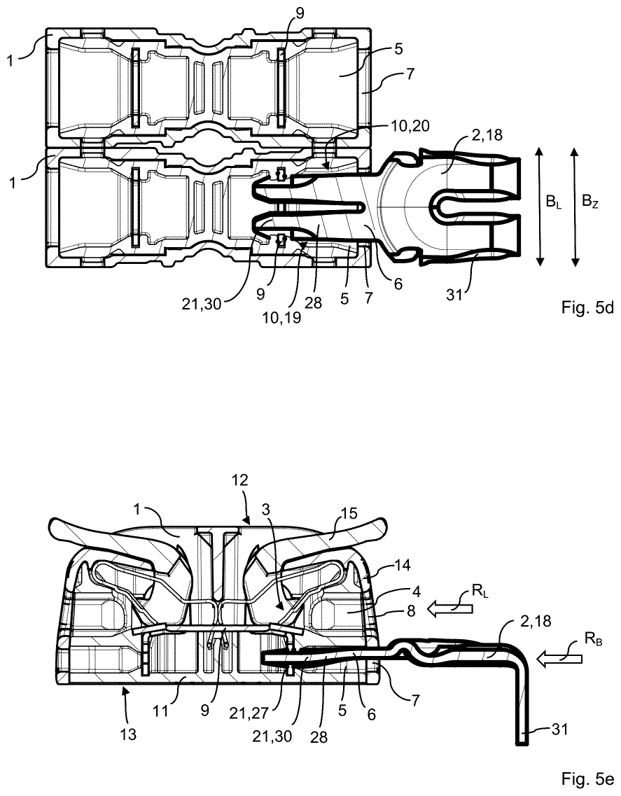

FIGS. 5a to 5e show a set of the invention in accordance with a fifth example. FIG. 5a shows two conductor connection terminals 1, in which an accessory element 2 is fastened. Conductor connection terminals 1 have similar dimensions and are arranged in series. In the variant of conductor connection terminals 1 shown in FIGS. 5a to 5e, the cross section of conductor insertion openings 8 and conductor insertion channels 5 is dimensioned and designed such that two electrical conductors can be inserted into conductor connection terminal 1 side by side.

According to the fifth example shown as an example in FIGS. 5a to 5e, accessory element 2 is a contact element 18, which is provided as a PE contact with a grounding plug 31 for a conductor connection terminal 1. The PE contact is used for the protective earthing of conductor connection terminal 1. As is evident in FIG. 5d, the width Bz of accessory element 2 designed as contact element 18 corresponds substantially to the width BL of a single conductor connection terminal 1.

Contact element 18 has a fastening section 6 which is inserted into accessory insertion channel 5 of conductor connection terminal 1 and fastened there, as this is shown by way of example in FIGS. 5a, 5d, and 5e. As is evident in FIG. 5d, fastening section 6 has a cross section of approximately the same size as the associated accessory insertion channel 5. Due to this design of fastening section 6, fastening section 6 can rest at least partially against the channel walls of accessory insertion channel 5 and is held securely there. The basic plug shape 19 and the basic channel shape 20 as plug contours 10 are thus matched to each other in this example and form corresponding plug contours 10.

As is evident in FIG. 5d, for example, fastening section 6 has a plug contour 10 with a basic plug shape 19 that is substantially rectangular in cross section, and accessory insertion channel 5 has a basic channel shape 20 that corresponds to the rectangular basic plug shape 19 of fastening section 6, is stepped and, depending on the step, is rectangular or trapezoidal in cross section, and has a number of shoulders against which the basic plug shape 19 of fastening section 6 can rest. Furthermore, the hold of fastening section 6 in accessory insertion channel 5 is improved by an additional plug contour 10 in the form of a split spring tongue 30 as fastener 21, which can be inserted into a contact slot 27 of busbar 9, which slot acts as fastener 21 and forms a plug contour 10, as shown, for example, in FIG. 5c.

Spring tongue 30 is formed from a predominantly electrically conductive material, in particular from a metallic material. Fastening section 6 according to the fifth example is therefore an electromechanical fastening section 6 with an electrical contact 28. In addition to the mechanical connection function, it also simultaneously fulfills electrical contacting functions of contact element 18. The divided spring tongue 30 is formed of two spring arms arranged next to each other, whose respective spring force causes spring tongue 30 to be pressed against the edge of contact slot 27 of busbar 9 for improved electrical contacting.

Spring tongue 30 can also have hook-like projections for a better hold on contact slot 27. Fastening section 6 is partially elastically deformable in the area of the spring arms. Spring tongue 30 can also be referred to as the plug tongue of contact element 18. In this example, plug contour 10 corresponding to plug contour 10, formed as a spring tongue 30, of fastening section 6 is not provided on accessory insertion channel 5, but on busbar 9 of conductor connection 3 of conductor connection terminal 1. This ensures a secure hold of fastening section 6 and a sufficient electrical contact between contact element 18 and busbar 9.

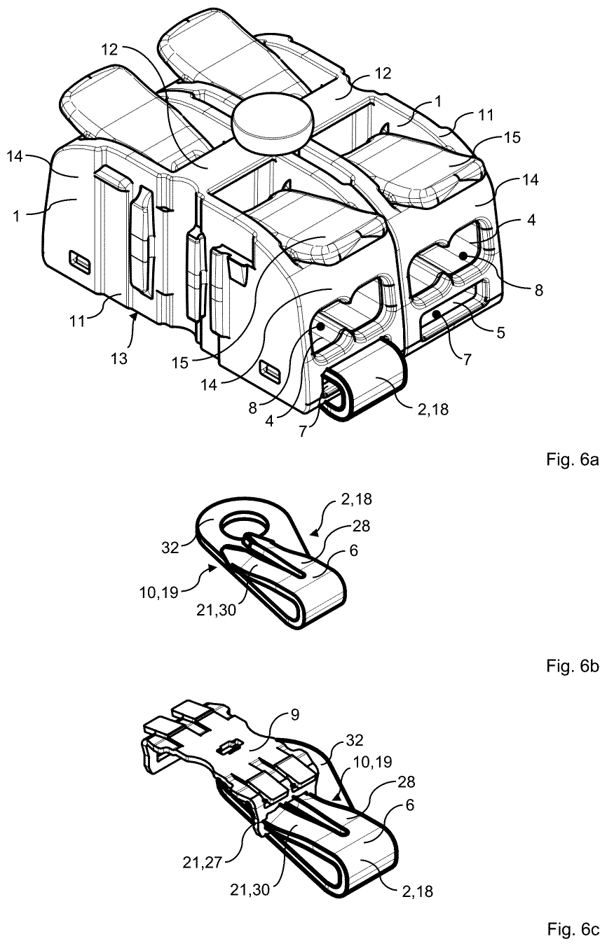

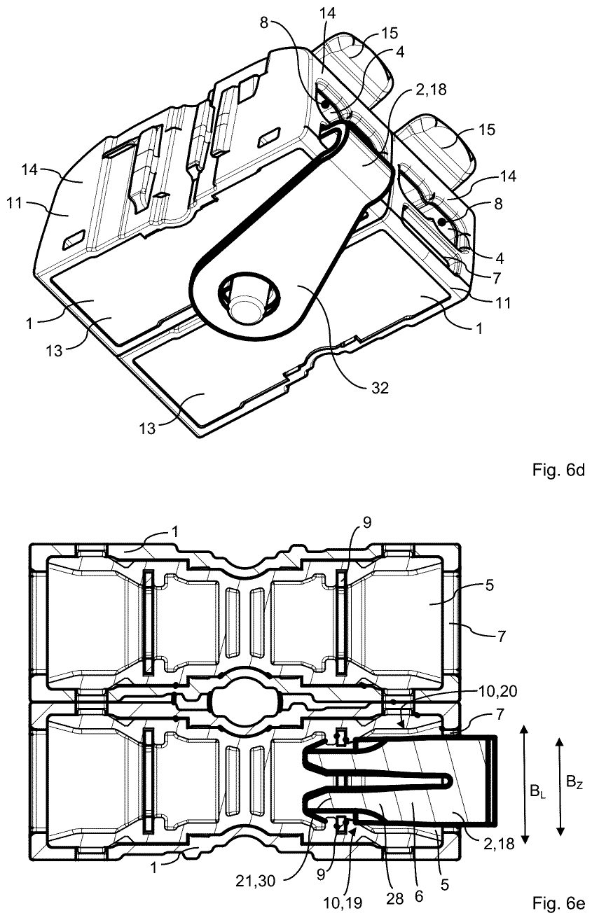

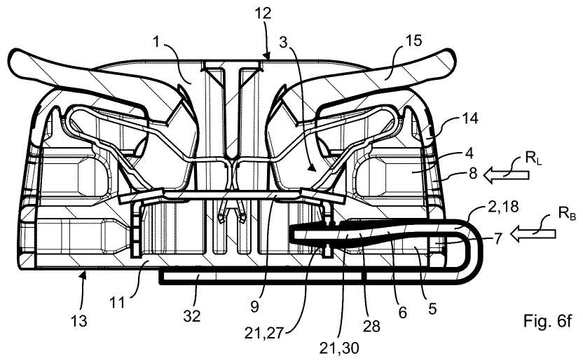

FIGS. 6a to 6f show a set of the invention in accordance with a sixth example. According to this example, accessory element 2 is a contact element 18, which is provided as a PE contact with an earthing plate 32 for a conductor connection terminal 1. The sixth example has some technical similarities to the fifth example, so that reference is made to the figure description for FIGS. 5a to 5e for an understanding of FIGS. 6a to 6f. It should be noted here that instead of an earthing plug 31, an earthing plate 32 is provided in the sixth example, which engages under conductor connection terminal 1 on its bottom side 13. In addition, accessory element 2 according to the sixth example has a smaller width Bz of accessory element 2 compared to the width BL of conductor connection terminal 1.

The advantages, according to the invention, of a variable and versatile fastening option for accessory elements 2 on accessory insertion channels 5 of conductor connection terminals 1 are also achieved for this type of PE contact.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A set comprising:
a conductor connection terminal; and
an accessory element to fasten to the conductor connection terminal,
wherein the conductor connection terminal has a conductor terminal for connecting an electrical conductor and has a conductor insertion channel for inserting and guiding the electrical conductor to the conductor terminal,
wherein the conductor connection terminal has, in addition to the conductor insertion channel, an accessory insertion channel, in which the accessory element is adapted to be selectively fastened with a fastening section of the accessory element.

2. The set according to claim 1, wherein the fastening section of the accessory element and/or the conductor connection terminal have a plug contour for fastening the fastening section in the accessory insertion channel.

3. The set according to claim 2, wherein the plug contour has or forms a pluggable geometric basic plug shape or a pluggable geometric basic channel shape.

4. The set according to claim 2, wherein the plug contour has or forms a fastener.

5. The set according to claim 4, wherein the fastener is a locking, a spring element, or a contact slot.

6. The set according to claim 2, wherein the plug contour of the conductor connection terminal is present on the accessory insertion channel and/or on a busbar of the conductor connection terminal.

7. The set according to claim 2, wherein the fastening section of the accessory element and the conductor connection terminal have mutually corresponding plug contours for fastening the fastening section in the accessory insertion channel.

8. The set according to claim 2, wherein the plug contour is formed from a predominantly electrically conductive material or from a predominantly electrically nonconductive material.

9. The set according to claim 1, wherein the fastening section of the accessory element is at least partially elastically deformable.

10. The set according to claim 1, wherein the conductor connection terminal has an insulating material housing with a top side, with a bottom side, and with housing side walls connecting the top side to the bottom side, wherein an accessory insertion opening of the accessory insertion channel is arranged in the same housing side wall as a conductor insertion opening of the conductor insertion channel of the conductor connection terminal.

11. The set according to claim 10, wherein the accessory insertion opening is located in the housing side wall closer to the bottom side of the insulating material housing than the conductor insertion opening.

12. The set according to claim 1, wherein the conductor insertion channel, when viewed in an insertion direction of the electrical conductor, extends substantially parallel to the accessory insertion channel in an insertion direction of the fastening section of the accessory element.

13. The set according to claim 1, wherein the accessory insertion channel has a smaller cross section than the conductor insertion channel.

14. The set according to claim 1, wherein the accessory insertion channel has a substantially rectangular, trapezoidal, or stepped cross section.

15. The set according to claim 1, wherein the fastening section of the accessory element has a smaller cross section than the accessory insertion channel.

16. The set according to claim 1, wherein the set has multiple conductor connection terminals that are arranged in series.

17. The set according to claim 16, wherein the accessory element has a width that is greater than the width of a single conductor connection terminal, wherein the accessory element is adapted to extend parallel to multiple conductor connection terminals arranged in series, and wherein the accessory element is fastened with the fastening section in at least one accessory insertion channel of one of the conductor connection terminals.

18. The set according to claim 17, wherein the accessory element has a plurality of fastening sections spaced apart such that the fastening sections are each be inserted into an accessory insertion channel of a conductor connection terminal or of conductor connection terminals arranged in series.

19. The set according to claim 18, wherein the fastening sections have a smaller cross section than the respectively associated accessory insertion channels and the fastening sections are each supported on different accessory insertion channel areas of the conductor connection terminal.

20. The set according to claim 1, wherein the conductor connection terminal has a busbar and wherein the fastening section, inserted into the accessory insertion channel of the accessory element ends before the busbar ends at the busbar or is fixed to a plug contour of the busbar.

21. The set according to claim 1, wherein the fastening section is a mechanical fastening section or an electromechanical fastening section with an electrical contact.

22. The set according to claim 1, wherein the accessory element is a strain relief unit, an information carrier, and/or a contact element.

23. The set according to claim 22, wherein an accessory element formed as an information carrier has a marker receptacle and a connecting section between the marker receptacle and the fastening section, wherein the connecting section has a constriction in the region of a conductor insertion opening of the conductor connection terminal when the accessory element is fastened to the conductor connection terminal.

24. The set according to claim 1, wherein the set has an adapter part with a fastening section, wherein an accessory element without a fastening section or an accessory element with an incompatible fastening section is adapted to be indirectly fastened in the accessory insertion channel of the conductor connection terminal using the adapter part.

25. The set according to claim 1, wherein the accessory element is adapted to be detachably fastened to the conductor connection terminal.

26. The set according to claim 1, wherein the conductor connection terminal has two accessory insertion channels that are substantially opposite each other and face each other.
